(19) United States
(12) Patent Application Publication
(10) Pub. No.: US 2009/0303098 A1
(43) Pub. Date: Dec. 10, 2009

(54) System and Method for Data Communication

(75) Inventor: Paul Wilkins, Cambridge (GB)

Correspondence Address: YOUNG BASILE, 3001 WEST BIG BEAVER ROAD, SUITE 624, TROY, MI, 48084, US

(73) Assignee: ON2 TECHNOLOGIES INC., Clifton Park, NY (US)

(21) Appl. No.: 12/477,420

(22) Filed: Jun. 3, 2009

Related U.S. Application Data
(60) Provisional application No. 61/059,367, filed on Jun. 6, 2008.

(51) Int. Cl. H04L 17/02; H04W 4/00

(52) U.S. Cl. 341/176; 455/466

(57) ABSTRACT

Disclosed herein is a method to enable a mobile device to function as a user interface to a remote application. The method includes actuating a user-actuated control on the mobile device to generate a device-output signal in accordance with a first protocol; transmitting the device-output signal over a licensed radio frequency spectrum to a wireless base station located on the same premises as the mobile device; establishing communication between the wireless base station and the remote application having a user interface that accepts a user-command signal in accordance with a second protocol that is incompatible with the circuitry and programming of the mobile device; generating a constructed-input signal based on the device-output signal; and transmitting the constructed-input signal to the remote application as the user-command signal in accordance with the second protocol to permit the mobile device to function as a controller for the remote application.

### CROSS-REFERENCE TO RELATED APPLICATIONS

This application claims priority to U.S. provisional patent application No. 61/059,367, filed Jun. 6, 2008, which is hereby incorporated by reference in its entirety.

### TECHNICAL FIELD

The present invention relates to wireless data communications generally and in particular to systems and methods for enabling a mobile device to function as a user interface to a remote application.

### BACKGROUND

In recent years, there has been an increase in the use of mobile devices, including mobile phones, laptops and MID (mobile Internet devices) and accordingly, a demand for access to a range of new data and voice services whilst on the move. In the home, the demand for wireless access to the Internet and other services traditionally provided through wired systems has partially been met by, for example, WIFI standards such as IEEE 802.11a, b, g and by emerging standards such as WiMAX.

On mobile phones, laptop computers and more recently on MID devices, there has been a growth in demand for ‘on the move’ access to the Internet and services such as email, web browsing and instant messaging. This demand was initially met using standards for transmitting data over the existing 2.5G mobile phone network, though the data rates available were low. The licensing of the so called 3G spectrum has opened up the possibility of higher bandwidth services including services that can in theory deliver multi-megabit download rates.

The content which mobile devices can access is increasingly complex and diverse. There has been a proliferation of different formats and protocols along with a growth in new services that mobile operators can offer to customers. For example, there are many different codecs used to play digital video. Some high end ‘smartphones’ contain general purpose CPUs or DSPs that can be programmed to process video and other data that is encoded or transmitted using one of many available formats and protocols. However, such general purpose CPUs and DSPs are expensive, and because video codecs are compute-intensive, processing this data may reduce battery life on the mobile device. Alternatively, mobile device can be equipped with special-purpose chips designed to decode or encode the data. These special-purpose chips have lower power requirements but are less flexible and it may not possible to retrospectively add support for new formats.

Access to mobile devices can be provided through a network of transmitters known as macrocells. Mobile devices can also include support for local area networking standards such as WIFI or WIMAX to permit access to Internet content and services through the local area network when within range of a suitable base station. This may require that each mobile device include additional RF chipsets to support the WIFI or WIMAX service as these can use a different part of the radio spectrum and different protocols than the mobile phone network. In the case of mobile phones, this can add to the cost of the handsets and limit access to newer handsets. Also, operators of mobile telephone network operators who have invested in the 3G or other network may lose control of the traffic over local area wireless network and thus, potentially lose ability to commercialize the added value services accessed by their customers through those local area networks.

In addition to macrocells, wireless networks can include femtocells, picocells and microcells. Generally speaking, femtocells can include low power local 3G base stations targeted at small buildings such as residential dwellings. Femtocells can operate in the same licensed spectrum as the operator's main 3G network and the handover between the main macrocell network and the local femtocell can be seamless as far as a user is concerned. However, access to femtocells is typically restricted to devices that have previously been registered to the cell. This ensures that the contention ratios in the femtocell remain low. Femtocells can link into the operators' main network and provide services through a wired Internet connection such as a DSL line.

Picocells and microcells are similar to femtocells but are targeted at larger buildings and developments such as hotels, offices, stadiums, railway stations and airports. They can also be used to provide service in areas or environments where there would otherwise be no service at all such as on ships (where connection to the main network is via satellite).

### SUMMARY

Embodiments of a method to enable a hand-held mobile communication device to function as a user interface to a remote application are taught herein. In one such embodiment, the method includes providing a hand-held mobile communications device having circuitry and programming. The hand-held mobile communications device is configured to transmit information over a radio frequency spectrum licensed to an operator of a public communications network A user-actuated control on the hand-held mobile communications device is actuated to generate a device output signal in accordance with at least a first protocol. The device output signal is transmitted over the licensed radio frequency spectrum to a wireless base station located on the same premises as the mobile communications device. Communication is established between the wireless base station and the remote application having a user interface that accepts a user-command signal in accordance with at least a second protocol that is incompatible with at least one of the circuitry and programming of the mobile communications device. The method further includes generating a constructed-input signal based on the device output signal. The constructed-input signal is transmitted to the remote application as the user-command signal in accordance with the second protocol to permit the mobile communications device to function as a controller for the remote application.

Embodiments of another method to enable a hand-held mobile communication device to function as a user interface to a remote application are taught herein. In one such embodiment, the method includes providing a hand-held mobile communications device having circuitry and programming. The hand-held mobile communications device is configured to transmit information over a radio frequency spectrum licensed to the operator of a public communications network. The mobile communications device is also configured to accept a device-input signal having a first format. The method also includes providing a wireless base station located on the same premises as the mobile communication device. The wireless base station has circuitry and programming configured to communicate over a computer network. Communication is established over the network between the wireless base station and the remote application having a user interface that generates an application-output signal incompatible with the first format and at least one of the circuitry and programming of the mobile communications device. A constructed-output signal is generated that is representative of the application-output signal but formatted in accordance with the first format and compatible with the circuitry and the programming of the mobile communications device. The constructed-output signal is transmitted to the mobile communications device as a device-input signal in accordance with the first format to permit the mobile communications device to function as an output display for the user interface of the remote application.

Embodiments of yet another method to enable a hand-held mobile communication device to function as a user interface to a remote application are taught herein. In one such embodiment, the method includes providing a hand-held mobile communications device having circuitry and programming. The hand-held mobile communications device is configured to transmit information over a radio frequency spectrum licensed to the operator of a public communications network. The mobile communications device is also configured to accept a device-input signal having a first format. The method also includes providing a wireless base station located on the same premises as the mobile communications device. A user-actuated control is actuated on the hand-held mobile communications device to generate a device-output signal containing a first type of data. Communication is established between the wireless base station and the remote application having a user interface. The user interface accepts an application-command input signal that contains a second type of data incompatible with the first type of data. The user interface also generates an application-output signal in response to the application-command input signal. The application-output signal is incompatible with at least one of the circuitry and programming of the mobile communications device. A constructed-input signal is generated having the second type of data. The specific data included in the constructed-input signal is selected based on the device-output signal. The constructed-input signal is transmitted to the remote application as application-command input signal in accordance with the second type of data to permit the mobile communications device to function as a controller for the user interface of the remote application. Further, a constructed-output signal is generated that is representative of the application-output signal but formatted in accordance with the first format and compatible with the circuitry and the programming of the mobile communications device to permit the mobile communications device to function as an output display for the user interface of the remote application.

Other embodiments of the invention are described in additional detail hereinafter.

### BRIEF DESCRIPTION OF THE DRAWINGS

The description herein makes reference to the accompanying drawings wherein like reference numerals refer to like parts throughout the several views, and wherein:

FIG. 1 is a block diagram of a system in accordance with one embodiment of the invention;

FIG. 2A is a flowchart illustrating the operation of the system of FIG. 1;

FIG. 2B is another flowchart illustrating the operation of the system of FIG. 1;

FIG. 3 is a first exemplary application of the system of FIG. 1;

FIGS. 4A and 4B are a second exemplary application of the system of FIG. 1; and

FIGS. 5A and 5B are a third exemplary application of the system of FIG. 1.

### DETAILED DESCRIPTION

On wireless communications networks, such as a 3G network, available bandwidth is contended by all the users in a particular mobile phone cell (or macrocell) and thus, the actual available bandwidth for users can fall off dramatically as the number of users rises. Further, the quality of service that can be delivered often falls off as users enter buildings or other environments where signal strength is attenuated.

To recover investment in wireless networks, such as the 3G network and associated licensing of spectrum, operators are increasingly looking to offer added value services such as streaming video and music to users. These added value services place a burden on the capacity of the existing 2.5G and 3G networks and even new technologies such as 4G can have difficulty with contention between users and attenuation of signal strength inherent with macrocells.

Femtocells, picocells and microcells provide a solution to operators that enable them to address quality of service and bandwidth problems that can be inherent with the delivery of high bandwidth services, while retaining control over the data traffic. They also eliminate the need for an expensive additional chipsets (such as to access WIFI or WIMAX) and can be accessed by any handset that is compatible with the operator's existing macrocell network.

It is estimated that 30% of mobile phone access takes place at home and 30% of mobile phone access takes place at work. Hence, deployment of femtocells in these environments can significantly reduce the load on the main network. Furthermore, because of the way that 3G macrocells work and that signal strength within buildings can be attenuated, removal of a single user making a call or using a service from within a building has a disproportionate effect on the quality of service for other users in the macrocell.

For high-end smartphones, it may be possible to download clients or software to support new services such as VOIP, email, web browsing and instant messaging. However, for low and midrange ‘feature phone’ devices based on custom hardware, it is often impossible to add native support for new services.

It would be desirable to provide additional, cost-effective systems and methods to provide high-speed wireless data communications to permit users of mobile devices to access video and other value-added content.

The embodiments disclosed herein can address the problem of restricted macrocell bandwidth in cellular networks while permitting mobile devices, including older mobile devices, to access services and formats (such as videos) that are not natively supported by mobile device. Further, the embodiments disclosed herein enable the mobile device to function as a user interface to a remote application. In other words, the mobile device can act as a controller and/or an output display for a user interface of the remote application.

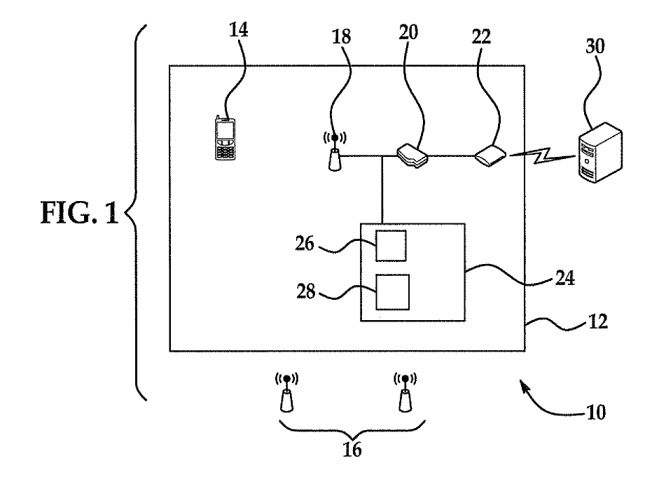

Referring to FIG. 1, a block diagram of a system 10 is illustrated in accordance with a first embodiment. System 10 happens in this case to be located in a residence 12, although it could be applied in an office, store or any other premises. As used herein, the term premises means a single location, which can include a home, office building, apartment, condominium building, or group of buildings on a single campus. A premises can also include an outdoor area such as a golf course, garden, swimming pool, park, nature preserve or other defined outdoor area. An end user can be equipped with a hand-held mobile communications device 14, which in this case is a cellular telephone registered to operate on a provider's network or public communications network 16. System 10 permits mobile device 14 to function as a user interface to a remote application 30.

Mobile device 14 is configured to transmit information in the form of device-output signals over a radio frequency spectrum licensed to the operator of provider's network 16 in accordance with a first protocol (i.e. native protocol). Alternatively, in other embodiments, mobile device 14 can transmit information in the form of device-output signals containing a first type of data (i.e. native type of data). The device-output signal can be, for example, a dual-tone multi-frequency (DTMF) signal, a sound wave, a short message service (SMS) message or any other signal that can be generated by mobile device 14 and transmitted over the radio frequency.

Further, mobile device 14 is configured to receive information in the form of device-input signals having a first format (i.e. native format). For example, mobile device 14 can include special-purpose chips to permit it to decode and encode data (including images, audio and video) in its native format. In one example, the native format can be MPEG-4. Alternatively, mobile device can also encode and decode data using a general-purpose CPU or DSP along with software or firmware or can use a combination of special-purpose and general-purpose hardware to code and encode a number of formats.

Remote application 30 can have a user interface that accepts user-command signals in accordance with a second protocol (i.e. application protocol) that are incompatible with the circuitry and programming of mobile device 14. For example, if the user of mobile device 14 wanted to permit a user to initiate a VOIP phone call, the circuitry and programming of mobile device 14 would be unable to initiate the call by actuating any of the controls on the mobile device. Further, the user interface of remote application 30 can also generate an application-output signal, which is also incompatible with the circuitry and programming of the mobile device. Essentially, because of their incompatibilities, mobile device 14 is unable to communicate with remote application 30 and remote application 20 is unable to communicate with mobile device 14. However, as will be discussed in more detail below, system 10 permits mobile device 14 to function as a controller and display for remote application 30.

With continued reference to FIG. 1, a femtocell 18 can have circuitry and programming to communicate over a computer network through a home router 20 and a modem 22, which in this case is a DSL modem. By “modem” it is meant any type of device that enables access to the Internet or other off-premises network where desired content is located. Modem, as the term is used can include, for example, cable modems or network cards. It will be appreciated that the operator of the network 16 or its corporate partners can also provide (and bill for) access to the Internet via modem 16, even though that access may be over landlines in total or in part. Further, mobile device 14 can establish wireless communication with femtocell 18 to transmit and receive information and/or signals. Specifically, mobile device 14 can transmit device-output signals to femtocell 18 and can receive device-input signals from femtocell 18, as will be discussed in more detail below.

An appliance 24 is provided to generate constructed-input signals based on the device-output signals received from mobile device 14. The device-output signals are incompatible with the user interface of the remote application because of their native protocol or the native type of data they contain. However, the constructed-input signal, which is generated by appliance 24, is compatible with the user interface of remote application 30. Appliance 24 can dynamically interpret and reformat the device-output signal to, for example, generate a sequence of instructions or commands to remote application 30. Appliance 24 can also generate the constructed-input signals, by for example, repurposing the device-output signal. The repurposing can occur by, for example, reformatting, transcoding, altering a frame rate, altering a bit rate, altering image dimensions, re-sampling, changing a number of bits per sample, mode conversion and translating.

In order for the mobile device 14 to function as a user interface for remote application 30, the user of mobile device 14 can actuate a user-actuated control thereon. The user-actuated control can be any part of a mobile device that is capable of generating a device-output signal such as buttons of keypad, microphone, camera, side buttons or any other control. When the end user actuates one of these user-actuated controls, the circuitry and programming of mobile device 14 can be configured to generate a device-output signal in accordance with a first protocol. In other embodiments, the device-output signal can be generated that contains a first type of data. Appliance 24 then, as discussed previously, generates a constructed-input signal for the remote application 30 based on the device-output signal. Accordingly, mobile device 14 can function as a keyboard, microphone, a mouse or any other input peripheral. The device-output signal can be a command, data, instruction or any other piece of information. The data can be voice data, text data or any other type of data.

Appliance 24 is also provided to generate constructed-output signals that are representative of the application-output signal but formatted in accordance with the first format of mobile device 14. Further, the constructed-output signals are generated so that they are compatible with the circuitry and programming of mobile device 14. The application-output signals are incompatible with mobile device 14 because of for example, the format they are initially generated in and because they are incompatible with the circuitry and programming of mobile device 14. However, the constructed-output signal, which is generated by appliance 24, is compatible with mobile device 14. Accordingly, mobile device 14 can function as a visual display, a screen display, a sound display or any other type of output peripheral to remote application 30.

Appliance 24 can generate the constructed-output signals, by for example, repurposing the application-output signal. The repurposing can occur by, for example, reformatting, transcoding, altering a frame rate, altering a bit rate, altering image dimensions, re-sampling, changing a number of bits per sample, mode conversion and translating. For example, appliance 24 may translate the application-output signal from stereo audio to mono audio that is compatible with mobile device 14. Further, the application-output signal can be any piece of information such as text, audio, still images, animation, video or any other piece of information.

Remote application 30 can be a web browser, a VOIP application, a chat room, an instant messaging service, a video game, email or any other application, program or service that the user of mobile device 14 desires to access. In some embodiments, remote application 30 will be a service or program that is associated with the Internet. However, in other embodiments, user of mobile device 14 will access a service that is residing locally on a remote computer. In other embodiments, the remote application can be located within appliance 24.

In one example, the user of mobile device 14 may desire to view video content that is residing on remote application 30. Remote application 30 can be, for example, an external website that can be accessed over the Internet via modem 22. In this example, the desired video content can be encoded under the VP7 format or VP8 format provided by On2 Technologies of Clifton Park, N.Y., which is different from the native format (MPEG-4) that can be decoded by mobile device 14. Mobile device 14 can communicate wirelessly with femtocell 18, which is coupled with router 20 so that a request for content, as will be discussed in more detail below, by the user can be directed through modem 22 from the user's residence 12 over the Internet to website 30. Website 30 can transmit the requested data (i.e. application-output signals)—in this case VP7 video content—over the Internet to the user's residence 12 via modem 22. Before transmitting the content to mobile device 14, the content is generated in the form of constructed-output signals by appliance 24 by, for example, transcoding the video content from VP7 to the device's native format (in this case MPEG-4). The constructed-output signals of the video may be representative of the original data (VP7 format), but are formatted in manner according to the first format and in a manner that is compatible with the circuitry and programming of mobile device 14. In this manner, mobile device 14 can access the content on website 30 without requiring (onboard mobile device 14) the software, hardware and power necessary to decode video in VP7 format.

Appliance 24 can communicate with femtocell 18 and modem 22 by a wired or wireless local area connection such as Ethernet or Bluetooth or can be otherwise coupled via, for example, a USB connection. Appliance 24 can be powered by household electric current (not shown) but can also be battery powered or powered by other elements of system 24. While shown here as separate units for the sake of clarity, in practice femtocell 18, appliance 24, router 20 and modem 22 can be all be part of the same physical device (including even a single chip) and communicate via high speed data buses, shared memory, or other comparable means, rather than separate devices communicating over a LAN.

Femtocell 18 and appliance 24 can be deployed on the same premises as mobile device 14, although appliance 24 could be remotely located (such as on an off-premises server connected to femtocell 18 via a wide area network). Generally, mobile device 14 can be operated within 1000 feet of femtocell 18.

Appliance 24 can include memory 26 and can generate constructed-input signals and constructed-output signals using general-purpose CPU 28 with software or firmware in memory 26. Alternatively, a DSP can be used in lieu of CPU 28. Alternatively, appliance 24 can use special-purpose chips or can use a combination of special-purpose and general-purpose hardware. Power consumption and heat dissipation, both problems on mobile phone handsets and other mobile devices, are less likely to be a problem on appliance 24, which may lend favor to a more flexible solution based on a general purpose CPU or DSP.

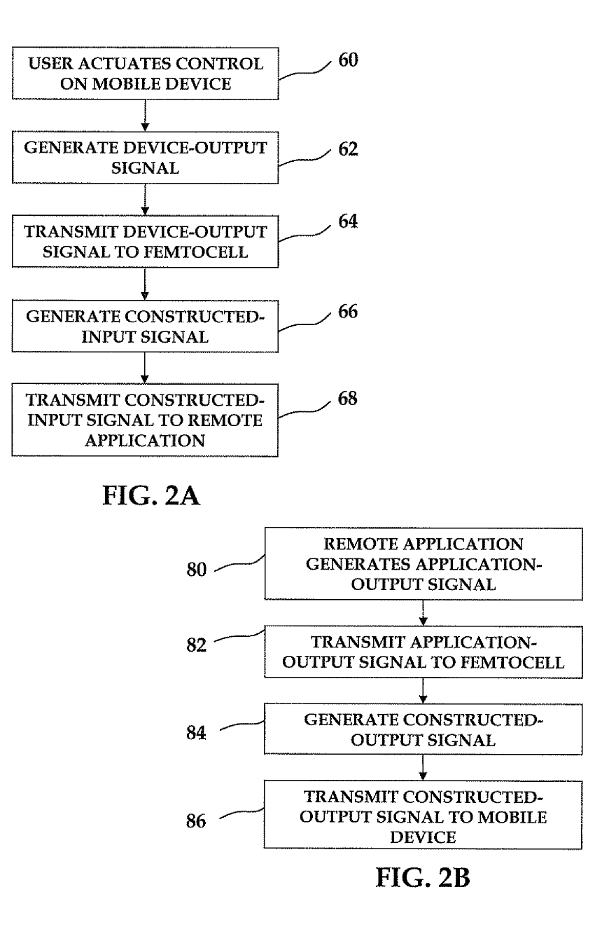

Referring to FIGS. 2A and 2B, the operation of system 10 is illustrated by way of logic flow charts. Specifically, FIG. 2A illustrates the operation when mobile device 14 is functioning as a controller of remote application 30 and FIG. 2B illustrates the operation when mobile device 14 is functioning as an output display for the remote application. Beginning at step 60, the user actuates a control on mobile device 14 to view content on a website, for example, by pressing the “#” key and then the “Send” key. At step 62, mobile device 14 generates one or more device-output signals in accordance with the first protocol. The device-output signal is then wirelessly transmitted to femtocell 18 at the user's residence 12 at step 64. At step 66, appliance 24 generates a constructed-input signal based in accordance with the second protocol. At step 68, the constructed-input signal is transmitted to remote application 30, by for example, the Internet via modem 22.

Beginning at step 80, remote application 30 (i.e. the website), generates an application-output signal. The application-output signal can be generated in response to the constructed-input signal or independently of any other factor. At step 82, application-output signal is sent to femtocell 18, by for example, the Internet via modem 22. At step 84, appliance 24 generates a constructed-output signal based that is representative of the constructed-input signal but that is compatible with the format, circuitry and programming of mobile device 14. At step 86, the constructed-output signal is transmitted to mobile device 14 via femtocell 18.

Control of processing as shown in FIGS. 2A and 2B can be implemented in the processor 28 in appliance 24 or can be distributive among the various elements of system 10.

Accordingly, appliance 24 can also function as a bridge or gateway that allows a mobile device 14 to access any type of Internet service. Appliance 24 can also function as a bridge or gateway that allows a mobile phone to link to a VOIP service without the need for installation of a special VOIP client. Appliance 24 can also reformat web pages to allow them to be more easily viewed on a mobile phone or other mobile device.

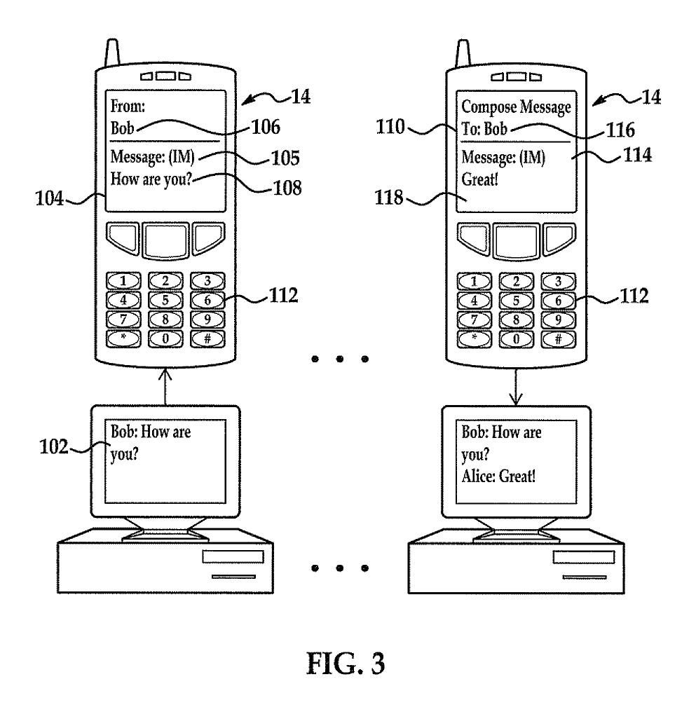

FIG. 3 shows an example of how the user of a mobile device 14 can chat using an instant messaging service. A user of a computer 100 can access an instant messaging service using a computer 100. User of computer 100 can initiate a chatting session with user of mobile device 14 by sending an instant message 102. Computer 100 is at a location remote from mobile device 14. Before transmitting the content to mobile device 14, appliance 24 generates instant message 102 in a format as represented by one or more constructed-output signals so that it may be received by user of mobile device 14. In the example of FIG. 3, the instant message 102 is generated to be of the format of an SMS message 104. Once instant message 102 is generated in a format suitable for mobile device 14, femtocell 18 can transmit the data to mobile device 14. The user of mobile device 14 can receive the message in the mobile device's native format, which in this case is an SMS message. The data can contain, for example, an indicator 105, sender information 106 and text 108. Indicator 105 can denote the original type of message format of the message sent by user of computer 100. Sender information 106 can contain identifying information of the user, such as a name, screen name, phone number of any other identifying information. In this example, indicator 105 ‘(IM)’ signifies that text 108 ‘How are you?’ was originally an instant message from an instant messaging service. Further, sender information 106 identifies that the sender is ‘Bob.’ Accordingly, even though mobile device 14 would not ordinarily be able to access the instant messaging service, system 10 provides the functionality that permits mobile device 14 to access services it would not otherwise have.

Similarly, user of mobile device 14 can send an SMS message 106 to user of computer 100. User of mobile device 14 can compose an SMS message 110 using a keypad 112. User of mobile device 14 can enter an indicator 114, destination information 116 and text 118. To communicate with a user of computer 100, the indicator 114 can be ‘(IM)’ so that an interpretable device-output signal is generated. However, in other embodiments, other techniques can be used to generate device-output signal that can be recognized and interpreted by appliance 24. Once user of mobile device 14 sends SMS message 110, femtocell 18 can receive the data so that appliance 24 can, for example, generate constructed-input signals that are compatible with the user interface of computer 100.

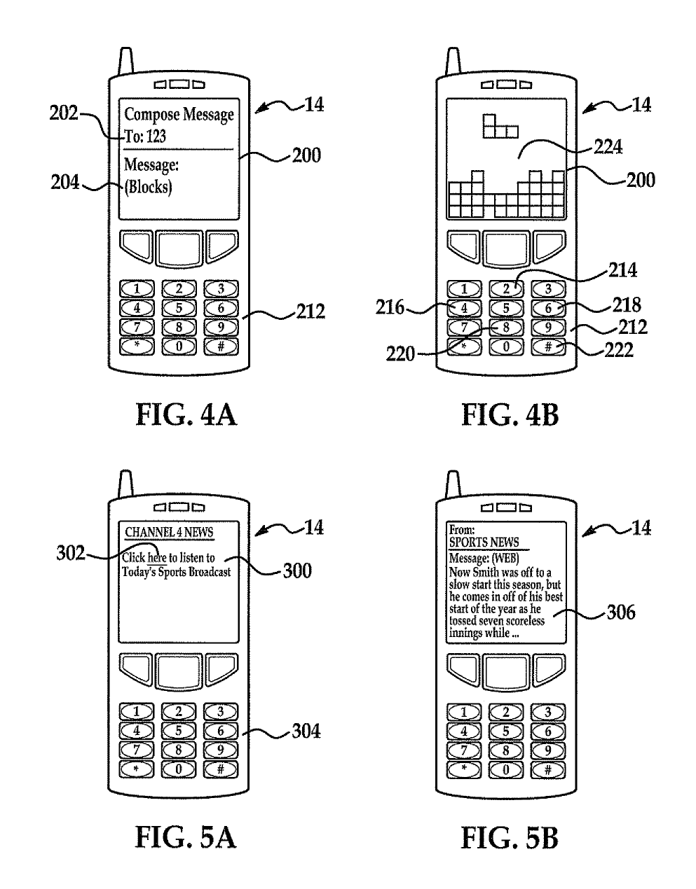

FIGS. 4A and 4B show an example of how the user of a mobile device 14 can use keypad 112 to play a video game. As shown in FIG. 4A, user of mobile device 14 can send an SMS message 200 containing destination information and an indicator 204 to femtocell 18. In the example illustrated in FIG. 4, ‘123’ can signify that the user of mobile device 14 desires to use the additional functionality of appliance 24 to play a game. In other embodiments, indicator 204 can be any other data such as an alphanumeric code and can be transmitted using any other technique. In this example, indicator 204 denotes that user of mobile device 14 would like to play the game ‘Blocks.’ Once user of mobile device 14 sends SMS message 200, femtocell 18 can receive the data so that it can be repurposed by appliance 24, Appliance 24 can contain, for example in memory 26, the application for the game ‘Blocks.’ User of mobile device 14 can access the game through appliance 24 and control the game using keypad 212.

As shown in FIG. 4B, appliance 24 can transmit images of the game in response to control by user of mobile device 14. In other words, appliance 24 can determine how to appropriately transmit data so that the game is appropriately displayed on mobile device 14. In this example, appliance 24 can transmit still images of the game to mobile device 14 via femtocell 18. Images can be transmitted, for example, periodically, such as every forty milliseconds. Depending on the application being accessed, transmission of data from appliance 24 may be period or non-periodic. For example, in a non-periodic transmission, appliance 24 may only send data in response to data sent from mobile device 14.

User of mobile device 14 can control the operation of the game by using keypad 212. Accordingly, if user selects button 214 corresponding to key ‘2’, a ‘flip block’ input can be transmitted to femtocell 18. If the user selects button 216 corresponding to key ‘4’, a ‘move block left’ input can be transmitted to femtocell 18. If the user selects button 218 corresponding to key ‘6’, a ‘move block right’ input can be transmitted to femtocell 18. If the user selects button 220 corresponding to key ‘8’, a ‘drop block’ input can be transmitted to femtocell 18. If the user selects button 222 corresponding to key ‘#’, a ‘PAUSE’ input can be transmitted to femtocell 18. Of course, different applications will have different keys corresponding to other functions. Depending on the type of mobile device 14, the user may submit other inputs using, for example, side buttons or any other functionality associated with mobile device 14. As the user is playing the game, appliance 24 receives data transmitted by mobile device 14 and can generate constructed signals in order to transmit an appropriate image 224 to mobile device 14.

Although in the example shown in FIGS. 4A and 4B, the video game application is part of appliance 24, the video game application can be accessed through the Internet or from any other content provider or device that can be in communication with femtocell 18. For example, the video game application may be developed in Java or Flash and be part of an Internet social networking site such as Facebook. Accordingly, when the video game application is on an external site, appliance 24 can be used to, as discussed previously, interpret signals from mobile device 14 and generate the appropriate constructed signals to the video game application and interpret signals from the video game application and generate the appropriate constructed signals to mobile device 14.

FIGS. 5A and 5B shows an example of how mobile device 14 that does not contain the capability for audio functionality can allow a user to access audio data from a web page. User of mobile device 14 can, for example, browse to a web page 300 containing, for example, a link 302 to an audio file. User of mobile device 14 can select the audio file using, for example, keypad 304. The user's request for data can be transmitted via femtocell 18 to appliance 324. Since mobile device 14 does not contain functionality to permit user 14 to listen to audio files, appliance 24 can repurpose the audio file by converting it to, for example, text 306.

Although in the example shown in FIGS. 5A and 5B, mobile device 14 receives the data as text, in other embodiments, appliance 24 can generate the output audio file by converting it to the device's native audio format. For example, the audio file may be in MP3 format but mobile device 14 may only support Adaptive-Multi Rate (AMR) format. Appliance 24 permits the user to access the audio data by, for example, generating and transmitting to mobile device 14 constructed-output signals of the converted audio data in the AMR format.

Accordingly appliance 24 can contain functionality in, for example, microprocessor 26 to convert the data from one mode to another. Although the example illustrated converts audio to text, conversion may audio to image, image to text or any other suitable mode conversion as desired or required.

In an alternative embodiment, appliance 24 can be integrated into femtocell 18. The functionality of appliance 24 can also be used with a picocell, femtocell, microcell or other wireless base station.

It will be seen that using the disclosed embodiments, operators of wireless networks can deploy and commercialize new services more quickly to users who do not necessarily need to upgrade handsets or other mobile devices.

While the invention has been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method to enable a hand-held mobile communications device to function as a user interface to a remote application, comprising:
providing a hand-held mobile communications device having circuitry and programming and configured to transmit information over a radio frequency spectrum licensed to an operator of a public communications network;
actuating a user-actuated control on the hand-held mobile communications device to generate a device-output signal in accordance with at least a first protocol;
transmitting the device-output signal over the licensed radio frequency spectrum to a wireless base station located on the same premises as the mobile communications device;
establishing communication between the wireless base station and the remote application having a user interface that accepts a user-command signal in accordance with at least a second protocol that is incompatible with at least one of the circuitry and programming of the mobile communications device;
generating a constructed-input signal based on the device-output signal; and
transmitting the constructed-input signal to the remote application as the user-command signal in accordance with the second protocol to permit the mobile communications device to function as a controller for the remote application.

2. The method of claim 1, wherein the wireless base station is one of a femtocell, a picocell and a microcell.

3. The method of claim 1, wherein generating the constructed-input signal based on the device-output signal includes:
dynamically interpreting and reformatting the device-output signal to generate a sequence of instructions in accordance with the second protocol.

4. The method of claim 1, wherein the device-output signal represents at least one of a command and data to the remote application.

5. The method of claim 1, wherein the data is at least one of voice data and text data.

6. The method of claim 1, wherein the device-output signal is at least one of a dual-tone multi-frequency (DTMF) signal, a sound wave, and a short message service (SMS) message.

7. The method of claim 1, wherein the remote application includes at least one of a web browser, a VOIP application, a chat room, an instant messaging service, a video game and email.

8. The method of claim 1, wherein generating a constructed-input signal comprises:
repurposing the device-output signal.

9. The method of claim 8, wherein repurposing includes at least one of reformatting, transcoding, altering a frame rate, altering a bit rate, altering image dimensions, re-sampling, changing a number of bits per sample, mode conversion and translating.

10. The method of claim 1, wherein the mobile communications device functions as at least one of a mouse, microphone and a keyboard for the remote application.

11. A method to enable a hand-held mobile communications device to function as a user interface to a remote application, comprising:
providing a hand-held mobile communications device having circuitry and programming and configured to transmit information over a radio frequency spectrum licensed to the operator of a public communications network; wherein the mobile communications device is configured to accept a device-input signal having a first format;
providing a wireless base station located on the same premises as the mobile communication device and having circuitry and programming configured to communicate over a computer network;
establishing communication over the network between the wireless base station and the remote application having a user interface that generates an application-output signal incompatible with the first format and at least one of the circuitry and programming of the mobile communications device;
generating a constructed-output signal that is representative of the application-output signal but formatted in accordance with the first format and compatible with the circuitry and the programming of the mobile communications device; and
transmitting the constructed-output signal to the mobile communications device as a device-input signal in accordance with the first format to permit the mobile communications device to function as an output display for the user interface of the remote application.

12. The method of claim 11, wherein the wireless base station is one of a femtocell, a picocell and a microcell.

13. The method of claim 11, wherein the application-output signal represents one of text, audio, still images, animation and video.

14. The method of claim 11, wherein the device-input signal is at least one of a dual-tone multi-frequency (DTMF) signal, a sound wave, and a short message service (SMS) message.

15. The method of claim 11, wherein the remote application includes at least one of a web browser, a VOIP application, a chat room, an instant messaging service, a video game and email.

16. The method of claim 11, wherein generating a constructed-output signal comprises:
repurposing the application-output signal.

17. The method of claim 16, wherein repurposing includes at least one of reformatting, transcoding, altering a frame rate, altering a bit rate, altering image dimensions, re-sampling, changing a number of bits per sample, mode conversion and translating.

18. The method of claim 11, wherein the mobile communications device functions as at least one of a screen display and a speaker for the remote application.

19. A method to enable a hand-held mobile communications device to function as a user interface to a remote application, comprising:
providing a hand-held mobile communications device having circuitry and programming and configured to transmit information over a radio frequency spectrum licensed to the operator of a public communications network; wherein the mobile communications device is configured to accept a device-input signal having a first format;
providing a wireless base station located on the same premises as the mobile communications device;
actuating a user-actuated control on the hand-held mobile communications device to generate a device-output signal containing a first type of data;
establishing communication between the wireless base station and the remote application having a user interface that: (i) accepts an application-command input signal that contains a second type of data incompatible with the first type of data; and (ii) generates an application-output signal in response to the application-command input signal, wherein the application-output signal is incompatible with at least one of the circuitry and programming of the mobile communications device;
generating a constructed-input signal having the second type of data, wherein the specific data included in the constructed-input signal is selected based on the device-output signal;
transmitting the constructed-input signal to the remote application as application-command input signal to permit the mobile communications device to function as a controller for the user interface of the remote application; and
generating a constructed-output signal that is representative of the application-output signal but formatted in accordance with the first format and compatible with the circuitry and the programming of the mobile communications device to permit the mobile communications device to function as an output display for the user interface of the remote application.

20. The method of claim 19, wherein generating the constructed-input signal based on the device-output signal includes:
dynamically interpreting and reformatting the device-output signal to generate a sequence of instructions having the second type of data.
